(19) United States
(12) Patent Application Publication
(10) Pub. No.: US 2010/0170757 A1
(43) Pub. Date: Jul. 8, 2010

(54) TORQUE BAR WITH INTEGRATED DISC BRAKE CALIPER MOUNTING

(76) Inventors: RAKESH KUMAR DHAWAN, DULLES, VA (US); Jeremy Douglas Boyle, Falls Church, VA (US); Mansour Peyghaleh, Sterling, VA (US); Mohammed Ziaur Rahman, Herndon, VA (US); Stephen Howard Sayre, Leesburg, VA (US)

Correspondence Address: Electric Motion Systems, LLC, 45150 Business Court , Ste. 300, Dulles, VA, 20166, US

(21) Appl. No.: 12/348,023

(22) Filed: Jan. 2, 2009

(51) Int. Cl. F16D 65/02

(52) U.S. Cl. 188/73.39

(57) ABSTRACT

A torque bar on a bicycle braking system comprising of a disc brake caliper assembly including an axle housing, a torque bar mounted to the stator of an inverted hub motor and vehicle frame, wherein said torque bar is attached to the vehicle frame and disc brake caliper and the torque produced by the stator of inverted hub motor is transmitted to the vehicle frame through said torque bar.

### FIELD OF THE INVENTION

The present invention relates generally to a light electric vehicle braking system, and more particularly to a torque bar with integrated disc brake caliper mounting.

### BACKGROUND OF THE INVENTION

The use of light electric vehicles, especially bicycles, are becoming an increasingly popular form of recreation as well as a means of transportation. Moreover, bicycling has become a very popular competitive sport. Whether the bicycle is used for recreation, transportation or competition, the bicycle industry is constantly improving bicycle components. One particular component of the bicycle, which has been extensively redesigned over the past years, is the braking systems of bicycles. In particular, the braking power of the braking systems is constantly being increased.

With increased use of bicycles in the context of today's heavy and rapid automobile traffic, it is becoming more important that a bicycle shall be able to stop with all possible speed and safety. It is known that two-wheel braking has the maximum potential for rapid stops, but the lack of adequate control of brake application renders such braking dangerous under “panic” stop conditions, particularly in the case of a light-weight racing-style machine wherein the rider's weight is dominant and is located relatively high and forward in relation to the span between axles.

There are several types of bicycle brake devices, which are currently available on the market. Examples of some types of common bicycle brake devices include rim brakes, caliper brakes and disc brakes. If a rider wants a very high performance brake system, then the rider typically wants a disc brake system. Disc brake systems provide a substantial braking power in relationship to the amount of braking force applied to the brake lever. Moreover, disc brake systems typically provide a high level of consistency in all types of weather and riding conditions. Of course, riders constantly desire better performance from disc brake systems, i.e., disc brake systems that have more braking power. Currently, there are many types of disc brakes that are currently available on the market.

In heavy duty disc brake systems it is common to use torque bars which are bolted or otherwise integral with axle housing castings to locate sliding calipers and lining carriers in proximity to the disc brake rotor. Torque bars allow lateral movement of the calipers and the carriers relative to runout of the rotor.

The relevant prior art methods, which will deal with disc brake systems in bicycles, are as follows:

U.S. Pat. No. 6,336,531 describes a braking disc assembly that is mounted on a bicycle hub to work along with a disc brake of the bicycle and is formed of a fastening seat, a disc body, and a plurality of connection sets. The fastening seat is provided with a plurality of clamping portions, with each clamping portion having two clamping pieces. The clamping pieces are provided with a through hole. The disc body is provided with a hollow portion and a plurality of insertion portions, with each inserting portion having a locating hole. The connection sets comprise a locking member, a fastening bolt, and a spring. The fastening seat is fastened in the hollow portion of the disc body by the locking member which is engaged with the fastening bolt via the through hole of the fastening seat and the locating hole of the disc body. The spring is fitted over the locking member such that the spring urges at one end thereof the fastening seat, and at other end thereof the disc body. The disc body is capable of making an adjustment in position at such time when the disc body is pressed against by two brake pieces of the disc brake of the bicycle.

U.S. Pat. No. 6,607,057 discloses a housing configured to be rigidly fixed to a bicycle frame containing a pair of opposing brake pad assemblies configured to reside on opposite sides of a disc operatively associated therewith. At least one of the brake pad assemblies is advanced and retracted relative to the disc by a drive mechanism along an advancement axis to effect braking. A pad wear compensation apparatus is operatively associated with at least one of the brake pad assemblies to advance the brake pad assembly along the advancement axis as it wears. The pad wear compensation apparatus includes an adjustment knob attached to the housing for rotation about a rotation axis and fixed against axial movement. A rotary to linear linkage between the linked brake pad assembly and the knob provides axial advancement of the brake pad assembly relative to the housing upon axial rotation of the knob in a select direction to fix a select distance between the at least one linked brake pad assembly and the disc with the brake pad assembly retracted.

U.S. Pat. No. 6,880,897 claims a hub adapter that is used to modify a bicycle wheel hub to provide for the mounting of a disc brake rotor and/or for the repositioning of the wheel spoke mount flange to accommodate the additional components of a disc brake system The hub adapter may be fixed to the host non-disc wheel hub by fastening bolts passing through the original spoke mounting holes or by other fastening means. The hub adapter may provide standard mounting holes for a disc brake rotor to be fixed to the hub adapter with fastening bolts. The hub adapter provides alternate spoke mounting holes on an alternate spoke flange, positioned in such a way so as to provide adequate clearance for disc brake components such as the disc brake caliper assembly, or in such a way as to change the length of the spokes and to modify the wheel stiffness. The hub adapter effectively becomes integral to the host wheel hub and critical to the primary function of the wheel hub, which is transferring load from the frame to the wheel.

U.S. Pat. No. 6,164,421 describes a bicycle disc brake assembly provided with a brake disc support with a pair of floating discs and a bicycle disc brake caliper with three friction pads. The center or intermediate friction pad is a floating friction pad. The bicycle disc brake caliper can be provided with a cooling system that transfers heat away from the actuating fluid. The bicycle disc brake caliper also has a housing with a piston unit. The housing has a frame mounting member sized to be coupled to a portion of a bicycle frame. The piston unit is movably coupled to the housing between a release position, in which the piston unit is spaced from a brake disc mounted to a wheel of a bicycle, and a braking position, in which the piston unit engages the brake disc of the bicycle wheel. The coolant member has a coolant area for receiving coolant to create a coolant heat sink that transfers heat from the housing. The housing can have an actuating passage in fluid communication with the piston unit to move the piston unit via an actuating fluid. Alternatively, a cable instead of actuating fluid can be used to operate the piston unit.

U.S. Pat. No. 6,877,594 claims a disc brake to be opened by torque and arranged between a drive shaft and a driven shaft and comprising a brake wheel arrangement arranged between the drive shaft and the driven shaft, a friction surface arrangement arranged to co-operate with the brake wheel arrangement, at least one spring device arranged to press the brake wheel arrangement and the friction surface arrangement axially against each other, and a cam arranged between the drive shaft and the brake wheel arrangement, and the cam causing by the impact of the torque or rotation of the drive shaft and the possible counter torque of the driven shaft the relative axial position between the brake wheel arrangement and the friction surface arrangement to change in order to detach at least partly the braking engagement against the spring force caused by the spring device.

The above prior art does not discuss the use of the torque bar to transmit torque as well as effectively secure the non-rotating center of an inverted in-wheel motor and the disc brake calipers to the frame of the bicycle. The present invention differs from the existent prior art in that it mounts to the tapped holes in a bicycle frame used for mounting a disc brake caliper. And this system effectively achieves the two goals of securing the non-rotating center of an inverted in-wheel motor and the calipers for the disc brake system to the frame of the bicycle. A purported advantage of this present invention is that no additional transmission system is needed.

It is accordingly an object of the invention to provide an improved braking system of the character indicated, inherently avoiding the deficiencies of past systems.

It will be apparent to those skilled in the art that the objects of this invention have been achieved by providing this torque bar disc brake mechanism. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This present invention may be summarized, at least in part, with reference to its objects.

The foremost object of the present invention is to present a torque bar used for mounting a disc brake caliper to the bicycle frame.

Another object of the present invention is to act as a part to transmit torque to the bicycle frame.

Another object of the present invention is to secure the non-rotating center of an inverted in-wheel motor to the bicycle frame.

Another object of the present invention is to provide an improved bicycle braking system which efficiently transfers torque and eliminates the possibility of braking difficulties in the course of stopping on normal pavement surfaces.

Yet another object of the present invention is to provide an improved bicycle braking system which efficiently transfers torque and eliminates the possibility of braking difficulties in the course of stopping on normal pavement surfaces.

A further object of the present invention is to provide a torque bar as to be applicable to a wide variety of sizes and styles of electric bicycles.

A further object of the present invention is to provide simple and easily installed torque bar which can be applied as a modification of the braking system of a variety of existing bicycles.

A general object is to achieve the above objects with a torque bar in braking system which has a relatively high degree of inherent safety and effectiveness.

Additional objects, advantages and novel features of the invention will be set forth in part in the description which follows, and in part will become apparent to those skilled in the art upon examination of the following, or may be learned by practice of the invention.

These and other objects and advantages and features of the present invention will be more readily apparent when considered in reference to the following description and when taken in conjunction with the accompanying drawings listed below.

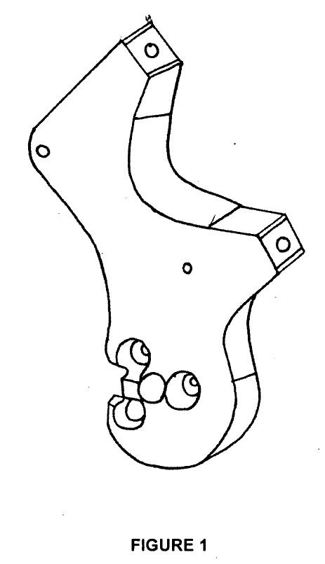

FIG. 1 is a perspective view showing the torque bar in its entirety.

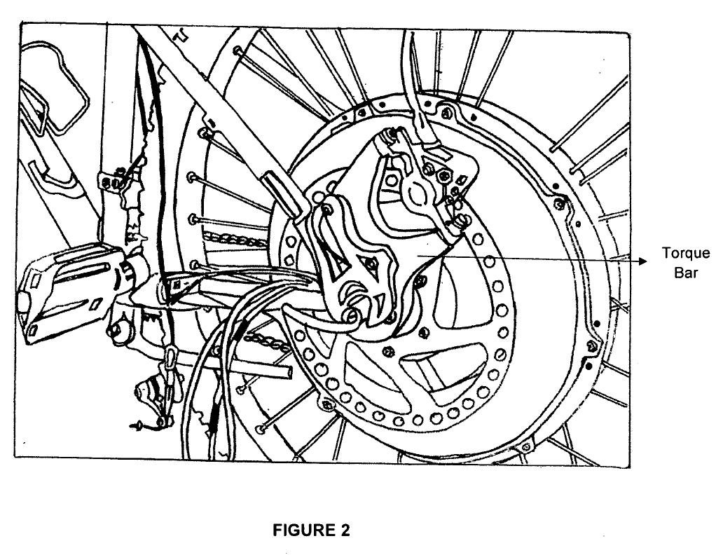

FIG. 2 is a perspective view of the torque bar in the brake disc system.

### DETAILED DESCRIPTION OF THE INVENTION

The following description is presented to enable any person skilled in the art to make and use the invention, and is provided in the context of particular applications of the invention and their requirements. The present invention can be configured as follows:

The present torque bar is designed for use in light electric vehicles such as a 1, 2, 3 or 4 wheeler and powered by an electric motor with an output power of less than 15 kW.

The non-rotating center of an inverted in-wheel motor must be secured to the frame of the vehicle. The calipers for a disc brake system must also be secured to the frame of the vehicle. To meet these two requirements, the present invention was designed.

The Torque Bar is a mechanical part which mounts to the stator of an inverted hub motor and to the vehicle frame. Thus, the torque produced by the motor is transmitted to the frame through the torque bar.

The overall association of the elements of the brake system including the present invention can be assessed from FIG. 2 which shows a disc brake caliper assembly including an axle housing, a torque bar mounted to the stator of an inverted hub motor and to the vehicle frame. The surfaces of the torque bar are generally flat or smooth and the torque bar is positioned parallel to the vehicle frame. The torque bar is equipped with threaded bores or alternatively blind bores that may receive bolts or cap screws which fasten it to the tapped holes in the vehicle frame.

FIG. 1 depicts the first arcuate member having an upper portion thereof for attachment to said disc brake caliper, a second arcuate member simultaneously attached to a second end of said disc brake caliper, said arcuate members having a lower portion extending perpendicular to said members and bearing said threaded bores or alternatively blind bores for attachment to said vehicle frame and said disc brake caliper.

While other methods of transmitting this torque have been developed, the present invention is unique in that it mounts to the tapped holes in a bicycle frame used for mounting a disc brake caliper. Since the holes used for conventional mounting of disc brake calipers to the frame are occupied in this design, another method for securing the caliper to the frame had to be developed. This requirement was satisfied by designing the present invention such that features on the part would allow a standard caliper to be mounted to it. The present invention acts as a part to transmit torque to the bicycles frame and also acts as a part to secure a braking mechanism (caliper) to the bicycles frame.

The effectiveness of the torque bar is not dependent on the direction of axle rotation or vehicle direction. The present invention provides equal torque transfer upon braking in either forward or reverse vehicle direction.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A torque bar on a light electric vehicle comprising of a disc brake caliper assembly mounted to the stator of an inverted hub motor and vehicle frame, wherein said torque bar is adapted for antirotational engagement to said vehicle frame, and for disc brake caliper mounting.

2. A torque bar as claimed in claim 1 wherein said torque bar is equipped with threaded bores or alternatively blind bores.

3. A torque bar as claimed in claim 1 wherein said torque bar comprises of first arcuate member having an upper portion thereof for attachment to said disc brake caliper.

4. A torque bar as claimed in claim 1 wherein said torque bar comprises of second arcuate member simultaneously attached to a second end of said disc brake caliper.

5. A torque bar as claimed in claim 1 wherein said arcuate members consist of a lower portion extending perpendicular to said members and bearing said threaded bores or alternatively blind bores for attachment to said vehicle frame and said disc brake caliper.

6. A torque bar as claimed in claim 1 wherein said torque bar is fastened to the tapped holes in said vehicle frame through said threaded bores or alternatively blind bores.

7. A torque bar as claimed in claim 1 wherein said disc brake caliper is mounted onto said torque bar through said threaded bores or alternatively blind bores.

8. A torque bar as claimed in claim 1 wherein the torque produced by the stator of inverted hub motor is transmitted to the frame through said torque bar.

9. A torque bar as claimed in claim 1 wherein the said light electric vehicle is a 1, 2, 3 or 4 wheeler and powered by an electric motor with an output power of less than 15 kW.
